(19) United States
(12) Patent Application Publication
(10) Pub. No.: US 2005/0040679 A1
(43) Pub. Date: Feb. 24, 2005

(54) Dimpled reclyclable substrate for an interior trim panel

(76) Inventors: Clarence P. Lipke, Fenton, MI (US); Scott Douglas Shields, White Lake, MI (US)

Correspondence Address: HONIGMAN MILLER SCHWARTZ AND COHN LLP, 32270 TELEGRAPH RD, SUITE 225, BINGHAM FARMS, MI, 48025-2457, US

(21) Appl. No.: 10/505,192

(22) PCT Filed: Feb. 11, 2003
(86) PCT No.: PCT/US03/04135

Related U.S. Application Data
(60) Provisional application No. 60/358,068, filed on Feb. 19, 2002.

(51) Int. Cl. B60R 13/02

(52) U.S. Cl. 296/214

(57) ABSTRACT

An interior trim panel, such as a headliner, formed by a substrate composed of a fibrous or porous batt material, such as polyethylene terephthalate (PET). The substrate includes a first, back side and second, front side. In order to increase the strength of the substrate, dimples or impressions are formed in the back side of the substrate and corresponding projections are formed extending from the opposite front side by simultaneously compressing both sides of the fibrous batt material. A structural layer of material is then attached to the substrate, preferably to the projections of the substrate, resulting in an “I-beam” structure that further enhances the strength of the interior trim panel. In another embodiment, a second layer of fibrous or porous batt material may be placed between the projections before fixedly attaching the structural layer of material to the substrate.

### BACKGROUND OF THE INVENTION

1. Field of the Invention

This invention is generally related to automotive interior trim panels, and in particular to a headliner composed of a fibrous or porous batt material, such as polyethylene terephthalate (PET) or the like, and a method for making the same.

2. Description of the Related Art

It is desirable within the field to produce an automotive trim panel, such as a headliner, composed of one type of material thereby permitting easier production along with easier recycling of excess or scrap material. The current standard is to use a fibrous batt material, such as polyethylene terephthalate (PET), which allows for easy molding and recycling. However, current headliners comprised of 100% PET typically lack sufficient durability and strength to carry modular components often required by them. To accommodate for this lack of durability and strength, either other types of material, such as glass, are added, which renders the headliner non-recyclable, or additional layers of raw material must be used, thereby needlessly increasing the overall weight of the headliner.

### SUMMARY OF THE INVENTION

The invention is directed to a substrate for an interior trim panel, such as a headliner, including a substrate composed of a fibrous or porous batt material, such as PET, which has a significant level of strength while minimizing the use of material to form a headliner that is relatively light in weight as compared to conventional headliners. This is accomplished by forming impressions or dimples into a first, back side of the PET batt material that extend through the full thickness of the layer to create projections that extend outward from a second, front side of the PET batt material. The impressions or dimples are formed by compressing both sides of the PET batt material to form a substrate with a relatively high density, but lighter is weight as compared to the conventional substrates. After compression of the PET batt material, a layer of material is then attached to the substrate such that the combination of the layer of material and the projections of the substrate form an “I-beam” structure that enhances the strength of the interior trim panel.

### BRIEF DESCRIPTION OF THE DRAWINGS

In the drawings:

FIG. 1 is a rear perspective view depicting a dimpled, recyclable substrate in accordance with the present invention.

FIG. 2 is a front perspective view depicting a headliner formed with the dimpled, recyclable substrate in accordance with the present invention.

FIG. 3 is a side perspective view of the headliner of FIG. 2 in accordance with the present invention.

FIG. 4a is a depiction of a first step in a method of manufacturing a dimpled, recyclable substrate in accordance with the present invention.

FIG. 4b is a depiction of the second step in the method of manufacturing the dimpled, recyclable substrate in accordance with the present invention.

### DESCRIPTION OF THE PREFERRED EMBODIMENT

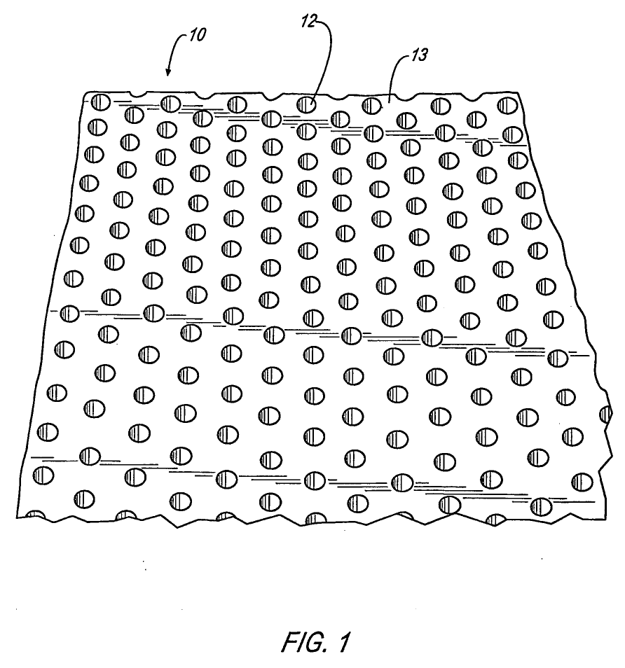

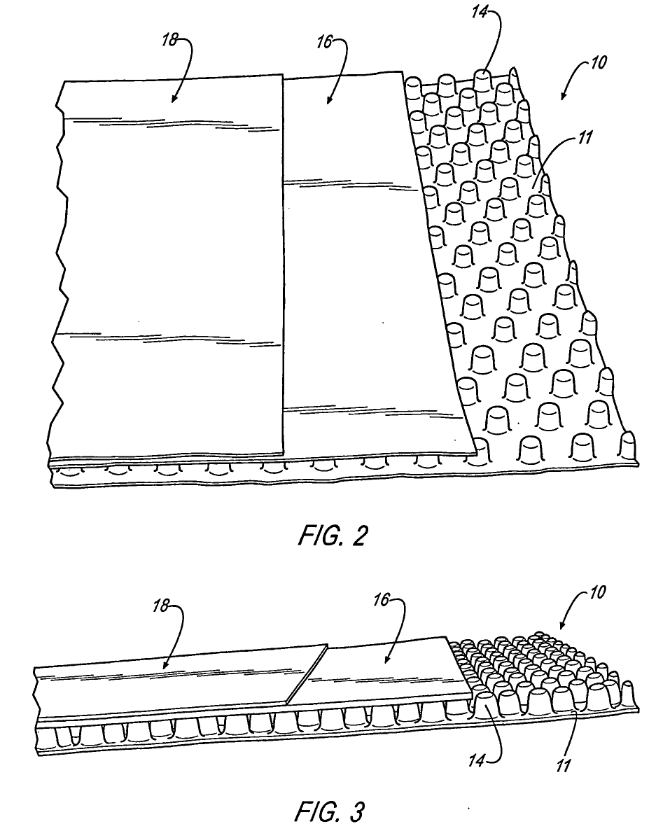

Referring now to FIGS. 1-3, the interior trim part of the invention comprises a substrate 10 formed of a fibrous sheet of polyethylene terephthalate (PET) batt material with a first, front side 11 and a second, back side 13. Specifically, the substrate 10 is formed to have dimples or impressions 12 running from the back side 13 of the substrate 10 and penetrate through the full thickness of the substrate 10 to the front side 11, resulting in a corresponding number of projections 14 extending outward from the front side 11 of the substrate 10. As used herein, the front side 11 of the substrate 10 is defined by the surface of the substrate 10 that is toward the interior of the vehicle (not shown), and the back side 13 of the substrate 10 is defined by the surface of the substrate 10 that is away from the interior of the vehicle.

After forming the dimples or impressions 12 and the corresponding projections 14, a structural layer of material 16 also made of recyclable PET material is attached to the projections 14 of the substrate 10, thereby forming an interior trim part that is made of 100% recyclable material. As best shown in FIG. 3, the combination of the structural layer of material 16 and the projections 14 results in an “I-beam” structure that has a synergistic effect of imparting greater strength to the headliner than either the substrate 10 or the structural layer of material 16 alone possesses. After the structural layer of material 16 is attached to the projections 14, a face fabric 18 can then be applied upon the second layer 16 to achieve an aesthetically pleasing appearance of the interior trim part. Alternatively, the face fabric 18 may be omitted or the structural layer of material 16 and the face fabric 18 may be designed to be one in the same.

Unlike conventional interior trim panels, the substrate 10 of the present invention is compressed on both the front and rear sides 11, 13 to form the impressions or dimples 12 that extend through its full thickness and the corresponding projections 14 that project outward from the front side 11. By compressing the front and rear sides 11, 13 of the substrate 10, a greater consolidation or higher density of fibers within the substrate 10 is realized. This process results in significantly enhanced strength while minimizing the amount of material used. As a result, a lightweight, but sufficiently strong interior trim panel can be achieved.

In the embodiment depicted in FIGS. 1-3, the impressions 12 and corresponding projections 14 are circular in shape. However, it will be appreciated that the invention is not limited to a shape of the impressions 12 and the corresponding projections 14, and that the invention can be practiced by using a variety of other desirable shapes based on matters such as preference, application or production considerations. Such shapes include, but are not limited to, square, diamond, hexagonal, rectangular, octogonal, triangular, or any polygonal shape.

As depicted in FIG. 1, the impressions 12 and corresponding projections 14 are arranged in a substantially linear pattern, with adjacent rows being offset from each other. This arrangement allows for an optimum number of impressions 12 and projections 14 per unit area to be achieved, leading to greater strength of the substrate 10 as compared to conventional substrates. However, it will be appreciated that the invention is not limited to this arrangement, but can be practiced by arranging the impressions 12 and the projections 14 in a variety of other geometric patterns depending on factors such as application or production considerations. Such patterns include, but are not limited to, square, diamond, hexagonal, rectangular, octogonal, triangular, or any geometric pattern that optimizes the number of impressions 12 and projections 14 per unit area of the substrate 10 for a particular application.

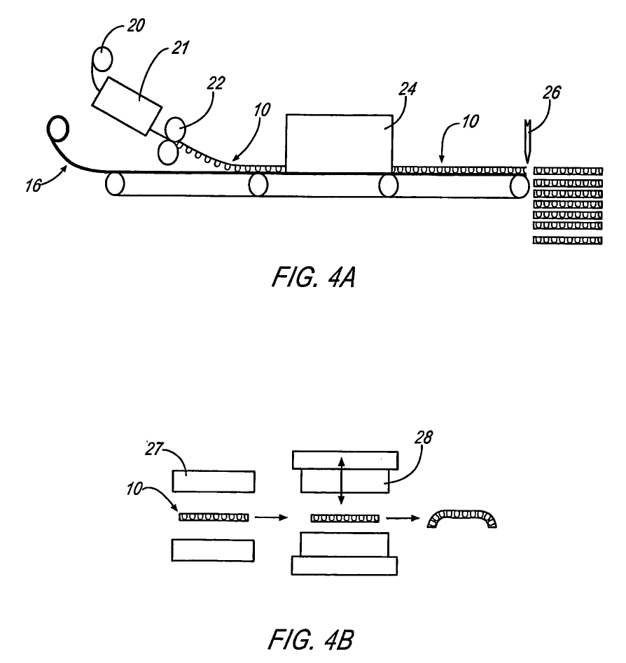

FIGS. 4a and 4b illustrate a method of manufacturing an interior trim panel, such as a headliner, with the substrate 10 and layer of material 16 according to the embodiment of the invention described above. Initially, a fibrous batt of PET material 20 is fed into a roller press 22 to compress and simultaneously create the impressions 12 on the back side 13 and the corresponding projections 14 extending outwardly from the front side 11, as shown in FIG. 4a. The fibrous batt 20 may be heated by a heater 21 prior to being compressed by the roller press 22. The compressed fibrous batt forming the substrate 10 has a higher density as compared to an uncompressed fibrous batt. The substrate 10 and the second, structural layer of material 16 are both fed into a compression heater 24 to fixedly attach the layer of material 16 to the projections 14 of the substrate 10. Then, the headliner substrate 10 with the attached structural layer of material 16 is cut to a desired length by a cutting means 26, such as a blade, or the like. As shown in FIG. 4b, the subsequent headliner substrate 10 could then be molded into the desired shape by a press 28. The headliner substrate 10 can be heated by an oven 27 prior to being molded by the press 28.

Alternatively, a second fibrous batt of PET material (not shown) can be placed between the projections 14 before the second layer of material 16 is fixedly attached to the substrate 10. Because the second batt of PET material is formed between the projections 14, this alternate embodiment of the invention provides improved sound absorbing properties, as compared to the first embodiment of the invention without the second fibrous batt.

Although not shown in FIGS. 4a and 4b, the face fabric 18 may be attached to the structural layer of material 16 in a manner similar to attaching the structural layer of material 16 to the substrate 10 prior to or subsequent to molding of the headliner substrate 10 to the desired shape by the press 24.

While the invention has been specifically described in connection with certain specific embodiments thereof, it is to be understood that this is by way of illustration and not of limitation, and the scope of the appended claims should be construed as broadly as the prior art will permit.

1-6. (Canceled).

7. A headliner, comprising:
a substrate including a first surface, and an opposite, second surface substantially parallel to said first surface forming a thickness of said substrate therebetween, said first surface having a plurality of impressions formed therein along a plane of said first surface so as to create a corresponding number of projections extending outwardly from said second surface substantially perpendicular to said plane of said first surface; and
a layer of material attached to said projections of said substrate,
wherein said layer of material together with said projections form an I-beam structure that enhances the strength of said headliner.

8. The headliner according to claim 7, wherein said substrate and said layer of material are comprised of polyethylene terephthalate (PET) material.

9. The headliner according to claim 7, wherein said substrate and said layer of material are comprised of 100% recyclable material.

10. The headliner according to claim 7, wherein said impressions and corresponding projections are arranged so as to have a maximum number per unit area of substrate.

11. The headliner according to claim 7, further comprising a face fabric attached to said layer of material.

12. The interior trim panel according to claim 7, wherein said plurality of impressions and corresponding projections form a two-dimensional array.

13. A method of manufacturing a headliner, comprising the steps of:
compressing both sides of a substrate so as to form a first surface, and an opposite, second surface substantially parallel to said first surface forming a thickness of said substrate therebetween, said first surface having a plurality of impressions formed therein along a plane of said first surface so as to create a corresponding number of projections extending outwardly from said second surface substantially perpendicular to said plane of said first surface; and
attaching a layer of material to the projections of the substrate,
whereby the layer of material together with the projections form an I-beam structure that enhances the strength of the headliner.

14. The method of claim 13, further comprising the step of attaching a face fabric to the layer of material.

15. The method of claim 13, further comprising the step of arranging the plurality of impressions and corresponding projections so as to have a maximum number per unit area of substrate.

16. The method of claim 13, wherein the plurality of impressions and corresponding projections form a two-dimensional array.
